(19) United States
(12) Patent Application Publication
(10) Pub. No.: US 2014/0150825 A1
(43) Pub. Date: Jun. 5, 2014

(54) CLEANING DEVICE FOR A THERMAL POWER PLANT, METHOD FOR INSTALLING A CLEANING DEVICE AND METHOD FOR CLEANING A THERMAL POWER PLANT

(71) Applicants: Nina Heißen, Wesel (DE); Christian Mueller, Dortmund (DE); Manfred Frach, Wesel (DE)

(72) Inventors: Nina Heißen, Wesel (DE); Christian Mueller, Dortmund (DE); Manfred Frach, Wesel (DE)

(73) Assignee: Clyde Bergemann GmbH Maschinen-Und Apparatebau, Wesel (DE)

(21) Appl. No.: 14/112,148

(22) PCT Filed: Apr. 13, 2012
(86) PCT No.: PCT/EP2012/056747

§ 371 Date: Jan. 2, 2014

(30) Foreign Application Priority Data
Apr. 21, 2011 (DE) 10 2011 018 441.4

(51) Int. Cl. F23J 3/02; B23P 11/00; F23J 11/00

(52) U.S. Cl. CPC F23J 3/023; F23J 11/00; B23P 11/00
USPC 134/18; 134/166 C; 134/113; 431/121; 29/428

(57) ABSTRACT

Techniques relate to a cleaning device for an interior of a thermal power plant carrying flue gases, especially a so-called soot blower. The cleaning device includes at least one rigid lance having a base and a lance add-on part which includes at least one nozzle, the lance add-on part being detachably connected to the base. At least the lance add-on part includes at least one sensor for measuring an environment parameter. The techniques further relate to a method for installing such a cleaning device and to a cleaning and monitoring method for defined areas of the interior of the thermal power plant.

The present invention relates to a cleaning device for an interior of a thermal power plant carrying flue gas. In addition, a method for installing a cleaning device and a method for cleaning a thermal power plant using such a cleaning device are specified.

In thermal power plants, a flue gas is produced as a result of combustion of fuels, waste materials and the like and, due to its temperature, is suitable for recovery of the thermal energy contained therein by means of subsequent contact with heat exchangers and/or by means of a heat transfer by radiation. Here, it is clear that, besides ash, soot, dusts, etc., aggressive gases, metal vapors and the like may also possibly be produced during the combustion process. These constituents contained in the flue gas attach during operation in particular to the walls and/or internal parts in the interior of the thermal power plant through which the flue gas is passed. Here, it has been observed that, as a result of the increasing attachment of such substances, the heat exchange between the flue gas and the heat exchanger medium becomes increasingly smaller and therefore the effectiveness or the efficiency of the thermal power plant reduces. For this reason, it is also known to clean the individual surfaces in the interior of the thermal power plant as required or to remove the pollutions, slag, etc. adhering there. This can be performed during a downtime of the thermal power plant, however such a cleaning process is preferably to be carried out during operation of the thermal power plant. Here, it must be taken into consideration that the cleaning process is performed such that the normal operation of the thermal power plant is only influenced to a small extent where possible.

The walls and/or heating surfaces of the thermal power plant in permanent contact with the flue gas, in particular the heat exchange surfaces, therefore have to be cleaned occasionally in order to ensure a sufficient cooling of the flue gas. Depending on the type and location of the pollution, different cleaning systems can be used in this case. Here, it is preferable to carry out the cleaning process during the operation of the thermal power plant, that is to say whilst fuel or waste material is burned in the combustion chamber or incineration chamber. The availability of the thermal power plant can thus be maintained over a particularly long period of time (what is known as the “operating time”).

Various cleaning systems are known for the cleaning of such heat exchange surfaces. For example, what are known as water lance blowers are used, which comprise a water lance which is positioned pivotably on the thermal plant and which can dispense a water jet selectively and with high energy through a hatch and for example through the incineration chamber onto wall regions arranged opposite and/or laterally. Such water lance blowers are to be used in particular where relatively large surfaces have to be cleaned and where these surfaces are easily accessible due to the pivoting range of the water lance blowers.

A further concept is constituted by what are known as soot blowers. These comprise an elongate tube with nozzles that are arranged at the end of the tube and are distributed over the periphery. This tube is then inserted temporarily into inner regions of the thermal power plant, wherein it can carry out a rotational movement in the meantime. During the movement in translation in the tube, the nozzles distribute steam (and/or air) or water in the peripheral direction at relatively low pressure. Such a soot blower can be used advantageously where narrow, drawn-out chutes or closely arranged shell-and-tube heat exchangers are provided in the interior of the thermal power plant, wherein, at the same time, there is sufficient run-out outside the thermal power plant for the lance tube leading out.

Furthermore, it is also known to infiltrate the thermal power plant by means of a cleaning system from above, for example into the empty passes, wherein a hose that is resistant to high temperature is lowered with a water distribution device at the end thereof. The water distribution device can thus dispense water in the peripheral direction onto adjacent walls up to a distance of 3 m to 4 m, simultaneously and/or on all sides as the hose is lowered and/or raised.

All of the above-mentioned cleaning systems raise the question of the trigger point for such a cleaning process during operation of the thermal power plant. Previously, fixed, predefined time intervals were primarily implemented, wherein these intervals were based on values gained from experience. Then, viewing windows or other optical aids were provided in the incineration chamber and/or downstream regions of the thermal power plant in order to thus obtain a subjective impression of the state of pollution of the incineration chamber or of the heat exchange surfaces and, where necessary, to start the cleaning process. In addition, the flue gas temperature when leaving the thermal power plant was monitored for example, wherein a cleaning process was performed once legally stipulated limit value temperatures were reached.

Furthermore, it is also considered to be known that the thermal power plant is equipped with temperature sensors and/or heat flow sensors in order to determine the temperature in the interior of the thermal power plant and/or the temperature of the heat exchange means. Furthermore, it is known to provide sensors to determine the weight of heat exchange surfaces, such that, on the basis of the weight, conclusions can be drawn regarding the residues adhering to the heat exchange surfaces. These temperatures or weight indications have likewise been used for selective cleaning as required of particularly polluted interiors of the thermal power plant.

Although the above-mentioned systems have already been used with large success, it is also desirable to achieve further improved monitoring of the processes in the interior of the thermal power plant so that the operation of the thermal power plant is disturbed even less by cleaning processes. This is to be achieved in particular by gaining more accurate information concerning the actual state in the interior or at the heat exchange surfaces, in particular where cleaning can be carried out with the aid of the available cleaning devices. In particular, a possibility with which existing thermal power plants can be equipped retrospectively with such monitoring systems or measuring systems with minimal technical effort is also to be created.

Lastly, it is also aimed to monitor the functionality or the actual mode of action of the cleaning device and to adapt this to the external ambient conditions in the case of cleaning devices that for example plunge deep into the interior of the thermal power plant. It is therefore also to be possible to monitor current cleaning parameters.

Based on the above, one object of the present invention is to at least partly solve the technical problems presented with reference to the prior art. In particular, a cleaning device for an interior of a thermal power plant carrying flue gas is to be specified, which can be adapted as required to various positions or to predetermined situations for use. In particular, the cleaning device is also to make it possible to provide information concerning the operating state of the cleaning device and/or the surrounding environment of the cleaning device in the interior of the thermal power plant. In addition, a method will be specified, with which such a cleaning device can be installed or retrofitted for use in the interior of a thermal power plant. In addition, a further objective of the present invention is to specify a method for cleaning a thermal power plant, wherein an improved monitoring of the slagging tendency or the cleaning efficiency during operation of the cleaning device or the thermal power plant is enabled with a cleaning device prepared accordingly.

These objects are achieved with a cleaning device according to the features of claim 1, a method for cleaning a cleaning device according to the features of claim 9, and a method for cleaning a thermal power plant according to the features of claim 10. Further advantageous embodiments are specified in the dependent claims. It is noted that the features mentioned individually in the claims can be combined with one another in any technically feasible manner and can present further embodiments of the invention. The description, in particular in conjunction with the figures, explains the invention and specifies further preferred exemplary embodiments of the invention.

The cleaning device according to the invention for an interior of a thermal power plant carrying flue gas comprises at least one rigid lance having a main body and at least one lance add-on part, wherein the lance add-on part comprises at least one nozzle, and wherein the lance add-on part is connected detachably to the main body.

In particular, this cleaning device is what is known as a soot blower. Soot blowers are known in different variants, for example as wall deslaggers, long retractable soot blowers, oscillating soot blowers, axial soot blowers, part retractable soot blowers, rotating element soot blowers, rake soot blowers or dual-media soot blowers. Wall deslaggers generally have two opposed high-power nozzles, which, during the cleaning process, clean off rear regions on the wall of the thermal power plant in a circular manner. Wall deslaggers are used in particular with persistent pollutions on the heating wall surfaces and with high flue gas temperatures. Long retractable soot blowers are used in particular for effective cleaning of persistent pollutions on tube bundle heating surfaces with high flue gas temperatures. To this end, at least two opposed high-power nozzles are likewise provided, which emit a helical cleaning jet during an axial and simultaneously rotating movement. With oscillating soot blowers, persistent pollutions specifically in predefined segments of tube bundle heating surfaces with high flue gas temperatures are cleaned. For this purpose, the oscillating soot blower is moved into and out from the chamber in an oscillating manner during the cleaning process, wherein the cleaning medium dispensed by the nozzles then cleans off these segments in a concentrated manner. In the case of axial soot blowers, merely an axial direction of movement of the lance is implemented, such that two opposed high-power nozzles regularly clean off only highly polluted tube bundle heating surfaces along line-shaped regions parallel to the lance. By contrast, a rotational movement of the lance is implemented simultaneously at least intermittently in the case of part retractable soot blowers, such that a helical blowing jet is also generated here and remedies persistent pollutions in particular on tube bundle heating surfaces. The rotating element soot blower actually performs only a rotational movement during the cleaning process and is held axially in a predefined position. Such rotating element soot blowers are suitable in particular for cleaning contaminated tube bundle heating surfaces. Rake soot blowers generally have a large number of high-power nozzles, which are aligned on one side (or a number of sides) of the lances. In the case of the rake soot blower, the lance is therefore moved axially into the interior, wherein the aligned high-power nozzles clean off fin coil heat exchangers with light pollution and at low flue gas temperatures in the manner of a rake. Lastly, dual-media soot blowers are also known, in which a selective use of different cleaning media (air, steam, water) is enabled. In this case, the cleaning media can be supplied to the surfaces to be cleaned in particular at accordingly adapted pressure. In the case of dual-media soot blowers, it is preferable if these can supply a liquid cleaning medium and also a vaporous/gaseous cleaning medium (at different times) to predefined cleaning surfaces.

With such cleaning devices, the rigid lance is then formed by a main body and at least one nozzle head, nozzle cover, nozzle arm, nozzle boom, or the like (all lance add-on parts). The rigid lance is in particular formed in the manner of a tube, wherein further concentric tube portions may be provided in the interior of the tube, for example in order to at least partly separate from one another cleaning media, cooling media, etc. An inflow region for cleaning medium to the nozzle head or nozzle arm or lance add-on part and additionally a backflow region can also be formed in the interior of the rigid lance so that the cleaning medium that does not exit through the nozzle is fed back again in order to cool the rigid lance. Such a rigid lance has a length of a number of meters, for example at least 5 m, or even 10 m, or even 15 m. It may be necessary to limit the length to 20 m in order to avoid an undesired deflection during operation. The lance add-on part of the rigid lance here routinely constitutes an (axial and/or lateral) end region of the rigid lance, which is introduced far into the inner regions of the thermal power plant or is arranged opposite the connection for the cleaning fluid. In this case, it is considered to be advantageous for the lance add-on part to comprise at least one nozzle. Of course, it is also possible for further nozzles to be formed in the remaining region of the rigid lance, in particular the main body. It is further preferable for the lance add-on part to have in particular at least two opposed high-power nozzles, which in particular are suitable for dispensing a high-energy liquid vaporous and/or gaseous cleaning jet. The lance add-on part can be formed in this respect in particular as a tube dome or tube arm closed on one side, wherein corresponding nozzles are inserted into bores in the lance add-on part and provide a connection from the inside out.

Here, it is then proposed for the rigid lance to be formed by two parts, specifically at least one lance add-on part and one main body, wherein the lance add-on part and the main body are interconnected detachably. That is to say, in other words, that the main body is formed in particular in the manner of a tube open on both sides and/or with at least one lateral discharge opening for the cleaning medium, and a closure on one side of the end region of the main body and/or of the discharge opening by means of the lance add-on part is achieved. For this purpose, the lance add-on part can be braced, screwed or suitably fastened to the main body such that the connection, even after one-time fastening of the lance add-on part to the main body, can then be detached again. In particular, the lance add-on part for the main body is thus exchangeable, and in particular different lance add-on parts for different purposes can thus also be arranged on the same main body. For example, this also allows simple maintenance or a technically simple replacement of the nozzles on the lance add-on part, for example should a nozzle be damaged or blocked. Furthermore, it is thus possible to respond easily to changed conditions in the interior of the thermal power plant, such that another operating mode or another jet direction of the cleaning medium can be adjusted with a replaced lance add-on part. Of course, care must be taken with this detachable connection between lance add-on part and main body to ensure that an accordingly suitable seal is provided here, which ensures the thermal and other requirements for the use of the cleaning device in an interior of a thermal power plant carrying flue gas.

In accordance with an embodiment of the cleaning device, it is also proposed for the lance to have a longitudinal drive for moving the lance in the direction of an axis of the lance. In particular, the cleaning device comprises a holder and a longitudinal drive, with which the lance can be moved in the axial direction, fixed by the holder. This longitudinal drive generally enables a substantially horizontal movement of the lance, wherein small angles of inclination for the lance can be implemented where necessary in order to compensate for a deflection of the long lance in the interior of the thermal power plant. In particular, electric motors, travelling slides, toothed racks or the like are used for this longitudinal drive. In this regard, reference is made to the known longitudinal drives for implementation of soot blowers.

The cleaning device may additionally also comprise a rotary drive. This can be coupled to the longitudinal drive such that a predefined longitudinal movement (necessarily) results in a matched rotation of the lance about its axis. Technically simple and robust drives for such a cleaning device can thus be implemented. It is also possible for the longitudinal movement of the lance to be decoupled from the rotational movement of the lance such that the longitudinal movement and the rotational movement can be carried out independently of one another, for example by providing separate motors or drives for the different movements. The decoupling of both movements has the advantage that a cleaning off of the polluted or slagged surfaces is made possible in a selective manner.

In accordance with a particularly preferred embodiment of the cleaning device according to the invention, at least the lance add-on part comprises at least one sensor for measuring an ambient parameter. In principle, it is possible for the lance add-on part to also comprise a plurality of sensors. The sensors may be in contact with the material of the lance add-on part, the outer environment and/or the inner environment. It is therefore possible in particular to measure an ambient parameter of the material of the lance add-on part, of the outer environment and/or of the inner environment of the lance add-on part. Here, it is preferable for the sensor to be connected to the lance add-on part such that this remains on the lance add-on part in the event of disassembly from the main body. It is most preferable if the lance add-on part forms a sensor system that can be operated independently of the embodiment of the main body or together with standard interfaces that are provided on a main body. The provision of such a combined sensor/nozzle lance add-on part in particular also allows the retrofitting of conventional soot blowers with an efficient evaluation unit or monitoring unit, as is then formed by the lance add-on part. Nevertheless, it is noted here that the functions may also be provided separately: the exchangeable or detachable lance add-on part therefore has at least one element from the group of nozzle and sensor.

Here, the term “sensor” is to be considered as a generic term for pieces of equipment with which the desired ambient parameters can be detected and/or which enable an analysis or monitoring of processes in the interior of the thermal power plant. Some examples of such sensors are as follows: displacement measuring system, camera, spectrometer, temperature gauge, gas probe, pressure gauge, etc.

In this regard, it is considered particularly advantageous for at least one sensor for measuring the external temperature or at least one sensor for measuring an internal temperature of the lance to be provided. It is most preferable if an individual sensor for measuring the external temperature is provided (in the interior of the thermal power plant) and if an individual sensor for measuring an internal temperature is provided (in the lance or in the lance add-on part). Consequently, the sensor for measuring the external temperature is arranged in contact with the external environment of the lance add-on part, whereas the sensor for measuring the internal temperature of the lance is directed inwardly. The sensor for measuring an external temperature is consequently in particular in contact with the flue gas in the interior of a thermal power plant during operation of the cleaning device. The sensor for measuring an internal temperature of the lance is preferably in contact with the cleaning medium (water, steam, air, etc.) during operation, such that the temperature of the cleaning medium can also be determined in particular. The exposed position of the lance add-on part during operation of such a cleaning device in the interior of a thermal power plant results in relatively high thermal loads and allows the collection of temperature data, which can otherwise only be measured with difficulty. This concerns the temperature of the flue gases at a distance for example of more than 10 m from the wall of the thermal power plant, and also the temperature of the cleaning medium actually just before discharge through the nozzle. This information can be used to analyze, to monitor, and, where necessary, also to adapt the cleaning process.

In addition, it is considered to be advantageous for the at least one sensor to be connectable to an evaluation unit, and for the lance add-on part to comprise connection means for a data transfer from the at least one sensor to the evaluation unit. The evaluation unit is used in particular to convert the measurement signals of the sensor into meaningful parameters, to compare the parameters with one another, etc. the evaluation unit therefore also comprises, for example, a processor unit or the like. Exposure of such an evaluation unit to high thermal loads, as experienced by the lance add-on part as it plunges into the interior, are to be avoided, such that the evaluation unit is advantageously arranged permanently outside the power plant. For this purpose, a corresponding region is provided on the cleaning device, however it is also possible for the evaluation unit to be positioned independently of the cleaning device at another point of the thermal power plant. Due to this distancing between sensor and evaluation unit, a simple, robust and reliable data transfer is to be implemented. For this purpose, the lance add-on part comprises (for example standardized) connection means, which implement a data transfer from the sensor to the evaluation unit. For a data transfer by means of cables, the connection means may comprise corresponding signal conductors, plugs, sliding contacts, etc. In this case, it should be taken into account however that suitable (electric) connection means are produced in accordance with the movement of the lance (axial and/or rotating movement). Here, the connection means are likewise preferably installed such that they can be separated or contacted without difficulty as the lance add-on part is attached to/separated from the main body and in the event of renewed connection between the lance add-on part and main body.

For further simplification of the assembly or disassembly, it is therefore proposed for the connection means to comprise at least one data transmitter for wireless connection to the evaluation unit. That is to say, in other words, the main body in particular has no connection means for a data transfer, but only the lance add-on part comprises at least one data transmitter, with which the measured values of the at least one sensor can be transferred wirelessly to the evaluation unit. For this purpose, the data transmitter can transfer the measured values for example via radio to the evaluation unit. In this case, radio frequencies are preferred, for example also in the form of Bluetooth® or RFID. This embodiment of the lance add-on part with a sensor that produces a wireless connection also further promotes the retrofitting of conventional cleaning devices with a corresponding sensor/nozzle lance add-on part.

In particular, a technique in which mechanical waves are generated at the surface of a piezoelectric substrate material, usually a monocrystalline piezoelectric substrate material, and are used for data transfer to an accordingly equipped receiver can be considered for such a wireless data connection. This can also occur in a coded manner in order to enable unambiguous association of the respective sensors.

The use of at least one such cleaning device described in accordance with the invention in a thermal power plant with an interior carrying flue gas is most preferred, wherein a wall of the interior has at least one hatch, in which the lance can be introduced at least via the lance add-on part into the interior. Furthermore, a longitudinal drive for moving the lance in the direction of an axis through the hatch is provided here and is arranged on a side of the wall opposite the interior. In other words, this means that such a cleaning device is installed here externally on the wall or on such a thermal power plant, such that the lance can be plunged temporarily at least via the lance add-on part through the hatch. A hatch for such a lance is routinely provided in the thermal power plant and can also be closed where necessary. It is also possible for a sealing air connection or a scavenging gas connection to be provided, which is positioned relative to the hatch such that no flue gases can escape before and/or during the plunging of the lance into the interior.

With such a thermal power plant, it is most preferable for the lance add-on part to be formed with at least one sensor and one data transmitter for wireless connection to an evaluation unit arranged outside the interior, and for the evaluation unit to be connected to the longitudinal drive. For this purpose, the evaluation unit can be equipped for example with a corresponding data receiver, such that the data from the interior of the thermal power plant can be radioed outwardly to the evaluation unit during operation. Based on the received data of the sensors of the lance add-on part, the evaluation unit can then influence the operation of the cleaning device, in particular the movement of the lance, such that a corresponding data connection or control line to the longitudinal drive is produced. In principle, it is also possible for information from the longitudinal drive to be forwarded to the evaluation unit, such that specific measurement procedures can then be initiated or terminated at predefined positions of the lance add-on part in the interior, for example depending on the path of travel.

In accordance with a further aspect of the invention, a method for installing a cleaning device for an interior of a thermal power plant carrying flue gas is specified, wherein the cleaning device comprises at least one rigid lance, and the method comprises at least the following steps:
a) separating the rigid lance of the cleaning device into a lance add-on part comprising at least one nozzle and a main body,
b) positioning at least one sensor on the lance add-on part,
c) providing remote data transfer from the sensor to an evaluation unit,
d) connecting the lance add-on part to the main body.

This method in particular is an approach with which conventional soot blowers can be retrofitted with an independent sensor/nozzle lance add-on part. Although this combined function is particularly preferable, this method can also be used, where necessary, only with the integration of nozzles or sensors.

For this purpose, the originally one-piece rigid lance can be first separated in a step a) such that a main body is formed and also at least one lance add-on part, comprising the end region and/or a side arm of the rigid lance (with at least one nozzle). This separated lance add-on part can then be prepared for the sensor system. To this end, at least one sensor is positioned on the lance add-on part (step b)). In accordance with the desired ambient parameters which are to be measured using the sensor on the lance add-on part, an appropriate arrangement of the sensor is to be undertaken. In order to now transmit the measured values generated using the sensor during operation of the cleaning device in a technically particularly simple manner, connection means for wireless remote data transfer are to be provided or positioned on the lance add-on part and, where necessary, at another point. Even if step c) for the lance add-on part is concluded, the lance add-on part thus prepared can be connected again to the rest of the main body using the at least one sensor and, for example, at least one data transmitter, wherein, in accordance with step d), a detachable connection between the lance add-on part and the main body is preferred.

With regard to the execution or shaping of the individual method steps for installing the cleaning device, reference is made in particular to the above explanations concerning the variants of the cleaning device according to the invention. In particular, this concerns the measures already described for the positioning the sensor, for the shaping of the sensor, for the fastening or forming of connection means for a remote data transfer or a data transmitter, and also the detachable connection between the lance add-on part and the main body.

In accordance with a further aspect of the invention, a method for cleaning a thermal power plant comprising an interior carrying flue gas by means of at least one cleaning device is also proposed, said cleaning device comprising a rigid lance having at least one sensor on a lance add-on part of the lance, said method comprising at least the following steps:
i) introducing the lance add-on part in the lance in an interior of the thermal power plant,
ii) measuring an ambient parameter,
iii) transmitting the measurement signals to an evaluation unit,
iv) selecting an operating mode of the at least one cleaning device,
v) cleaning specific regions of the interior in accordance with the selected operating mode.

The method described here for cleaning the thermal power plant is implemented in particular using a cleaning device of the above-described type, in particular of the type according to the invention. In this regard, reference is made to the explanations there regarding a more detailed characterization of the cleaning device and functions or modes of operation thereof.

In other words, this method for cleaning a thermal power plant can be used simultaneously also for monitoring of the current processes in the thermal power plant or also in the lance. For example, such a cleaning step or such a monitoring process can thus be initiated after predefined intervals and/or as a result of corresponding cleaning routines which are based on other sensor measured values where appropriate. To this end, at least the lance add-on part of the lance is first introduced into the interior of the thermal power plant in accordance with step i). The lance add-on part thus reaches even sectors in the interior of the thermal power plant distanced far from the wall of the thermal power plant. If such a position or such a sector is then to be reached, a measurement process can be initiated here. To this end, an ambient parameter, which in particular is an ambient parameter from the group of external temperature in the interior of the thermal power plant and internal temperature of the lance, is determined by means of a sensor on the lance add-on part of the lance. Where necessary, the ambient temperature can be measured a number of times, such that step ii) may be carried out a number of times in some circumstances. It is also preferable for steps i) and ii) to be carried out at least partly at the same time.

The measured ambient parameters can be transmitted directly and/or in a bundled manner to the evaluation unit. This preferably occurs wirelessly. That is to say also, in other words, that step iii) is then carried out when the lance add-on part of the lance is arranged in the interior of the thermal power plant, wherein the evaluation unit is simultaneously positioned outside the interior of the thermal power plant. The measurement signals are therefore preferably transmitted by means of a radio technology. The measurement signals received by the lance add-on part of the lance can then be used as a basis for the selection of a predetermined operating mode of the at least one cleaning device. For example, it is then possible to decide the pressure or volume flow at which the cleaning medium is to be dispensed, the points at which cleaning medium is to be dispensed, the state of matter in which the cleaning medium is to be provided, the period of time over which the cleaning medium is to be dispensed, the intervals over time at which the treatment of the surface to be cleaned is to be implemented by means of different cleaning media, etc. The control of the cleaning device or the evaluation unit normally has corresponding cleaning routines or selection criteria for this purpose, such that a predetermined operating mode, which is stored for example, can be selected automatically under consideration of the received measurement signals. The corresponding information for implementing the desired blowing jet and/or the desired movement of the cleaning device is then transmitted for example to the drive of the cleaning device and/or the appropriate pieces of equipment for providing the cleaning medium. It is then made possible, in accordance with step v), for the predetermined regions of the interior to be cleaned in accordance with the selected operating mode. Although it is possible in principle to carry out steps ii) and v) in parallel at least at times, a separate mode of operation of the cleaning device with a measuring procedure and a cleaning procedure is preferable. This can also be predefined for example by the movement of the cleaning device or of the soot blower.

The invention and also the technical field will be explained in greater detail hereinafter on the basis of the figures. It is noted that the subjects illustrated in the figures are schematic and are not intended to restrict the invention. The figures also show most preferred exemplary embodiments of the invention. In the figures:

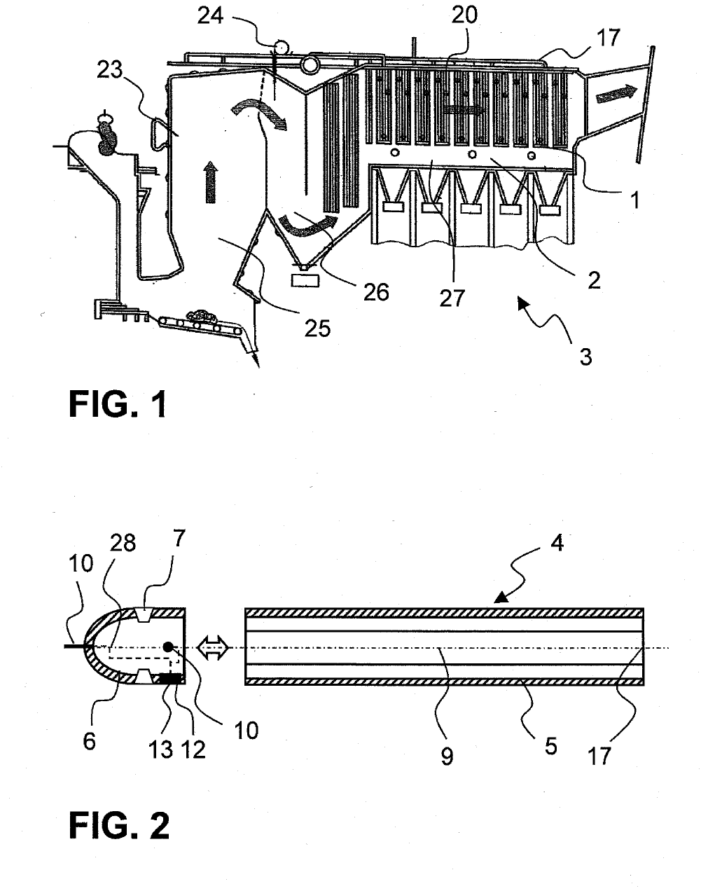

FIG. 1: shows an overview of a thermal power plant,

FIG. 2: shows a detail of a cleaning device,

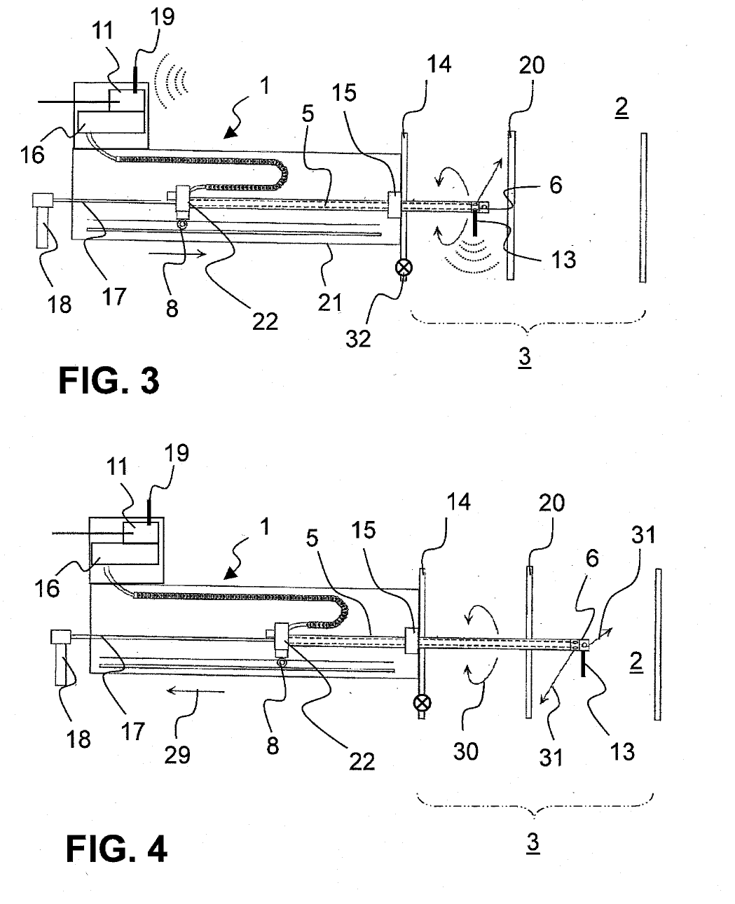

FIG. 3: shows a cleaning device in a first operating situation,

FIG. 4: shows the cleaning device from FIG. 3 in a second operating phase, and

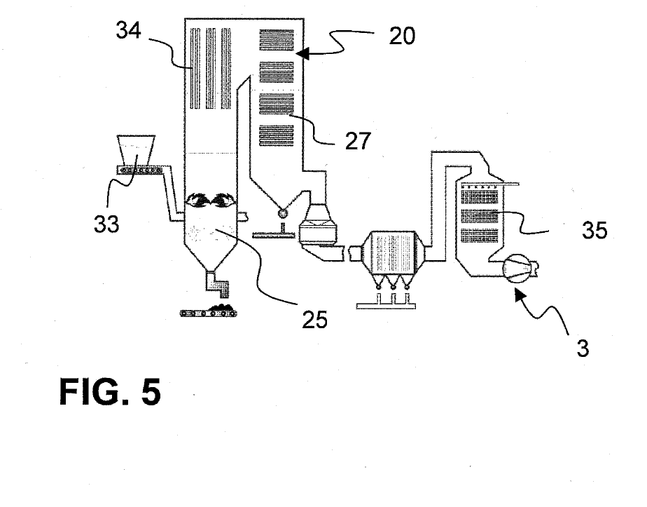

FIG. 5: shows an overview of another thermal power plant.

FIG. 1 shows a thermal power plant 3 comprising a fuel chamber 25 (or incineration chamber), in which a fuel or waste material is burned. Flue gas then flows along the interior 2 of the thermal power plant 3 and in so doing comes into contact with the walls of the thermal power plant or heat exchangers 20 arranged therein. Here, the flue gas flows, as denoted here by arrows, starting from the fuel chamber 25, for example via empty passes 26, into a convection part 27, before it leaves the thermal plant 3. Specifically in the last-mentioned part, a large number of heat exchangers are arranged, in particular shell-and-tube heat exchangers in the form of packets, through which a cooling fluid (for example) flows. Due to the contact between the hot flue gas and the heat exchangers 20, the thermal energy is transferred from the flue gas to the cooling fluid and can be removed for further use. It is specifically these heat exchanger surfaces 20 and also the walls of the thermal power plant 3, which delimit the interior, that are therefore polluted or slagged during operation.

The thermal power plant 3 illustrated here comprises different systems for cleaning these regions. In the region of the fuel chamber 25, a pivotable water lance 23 (in the form of a water lance blower) is arranged, of which the nozzle is positioned fixedly in a hatch, wherein, by means of a high-energy water jet, opposed and adjacent wall regions can be cleaned off by means of an accordingly meandering guidance of the blowing jet. In the region of the empty pass 26, a suspended hose system 24 is provided above and can be lowered through a ceiling region. At the end of the hose, a nozzle is provided, which can clean off the lateral wall regions at the height of the nozzle. In the convection part 27, a plurality of cleaning devices 1 are provided in the form of soot blowers and can plunge deep into the narrow gaps between the individual tube bundles of the heat exchangers 20. In this case, all cleaning devices 1 and, where applicable, also the pivotable water lances 23 or suspended hose systems 24, are connected to a common fluid line 17, wherein the different fluids are provided in separate line systems where necessary.

FIG. 2 shows a rigid lance 4 of a cleaning device according to the invention, wherein the rigid lance is formed here with a main body 5 and a lance add-on part 6, which are illustrated separated from one another. The lance add-on part in the form of a nozzle head can be connected detachably to the main body. The main body 5 may additionally be formed with the fluid line 17 at one end, wherein the fluid line 17 also extends into inner regions of the main body 5 where necessary. The main body 5 is formed in the manner of a tube with an axis 9. The lance add-on part 6 forms a dome-shaped end region of the lance 4, which has two oppositely arranged high-power nozzles 7. To measure the external temperature, a first sensor 10 is illustrated to the left, and to measure the internal temperature in the lance 4, a second sensor is provided opposite the fluid line 17 close to the nozzles 7 in the interior of the lance add-on part 6. Both sensors 10 are connected via signal conductors 28 to connection means 12 or a data transmitter 13. The measurement signals detected by means of the sensors 10 can be transmitted via these connection means 12 or the data transmitter 13 to a remote evaluation unit (not illustrated here).

FIG. 3 shows a variant of a cleaning device 1 in the form of a soot blower. The soot blower 1 is positioned on a wall 14 of the thermal power plant. The wall 14 comprises a hatch 15, through which the lance add-on part 6 or the main body 5 of the cleaning device 1 can penetrate into the interior 2 of the thermal plant 3. Heat exchangers 20, which are indicated schematically here and which can be cleaned off by means of this cleaning device 1, are provided in this interior 2. The cleaning device 1 additionally comprises a holder 21, on which a longitudinal drive 8, a rotary drive 22, a fluid line 17, where necessary also a connection 18 (valves, etc.) for the fluid line 17, and also a control 16 for the operation of the cleaning device 1 is positioned, for example. In this case, an evaluation unit 11, which is formed with a data receiver 19, is also part of the control 16.

In this case, it is now illustrated that the lance of the cleaning device 1 is introduced into the interior 2 of the thermal power plant 3 filled with flue gas. A corresponding arrow beneath the longitudinal drive 8, which is representative of this axial movement, illustrates this. During this insertion of the lance add-on part 6 of the lance into the interior 2 of the thermal power plant 3, an ambient parameter is measured, in particular the external temperature in the interior 2 of the thermal power plant.

The lance add-on part 6 of the cleaning device 1 is additionally formed with a data transmitter 13, with which a wireless transmission of the measurement signals to the externally arranged evaluation unit 11 is enabled. For this purpose, it may be expedient not to provide direct transmission of the measurement signals from the data transmitter 13 of the lance add-on part 6 to the data receiver 19 of the evaluation unit 11, but to implement this communication via a distributor 32. In particular due to the conditions, which may be difficult for radio transmission, this may in particular provide a reliable detection of the measurement signals in the interior 2 and a forwarding of these measurement signals for the external region. Based on the received measurement signals, which may be processed by means of the evaluation unit 11 where necessary, a decision aid for the cleaning steps or the operating mode of the cleaning device 1 actually to be implemented can be delivered to the control 16. Although the wireless data transmission is explained here in detail, the measured value recording and measured value transmission may also in principle take place in a wired manner, for example by means of a slip ring, such that this measured value transmission is also ensured during the movement of the cleaning device.

As illustrated in FIG. 4, the control 16 now regulates the actual cleaning operation of predetermined regions of the interior 2. Here, cleaning is possible for example with reverse direction of travel 29, with a rotation of the lance in the direction of rotation 30 and/or with a direction of spraying 31 starting from the lance add-on part 2 or the lance. Only for the sake of completeness is it noted that the predetermined regions of the interior 2 can be selected in a targeted manner by implementing a corresponding direction of travel 29 and/or a direction of rotation 30. A predefined movement is always repeated regularly in the case of soot blowers, since corresponding mechanical lead-away systems are provided. In principle, it is also possible however for independent drives for the direction of travel and/or the direction of rotation to be provided, such that the movement paths can be adjusted freely, in particular under consideration of the obtained measurement signals.

FIG. 5 illustrates the structure of a thermal power plant 3 in the utility industry. Here, the fed combustion material 33 is first burned, and the flue gas then flows, starting from the fuel chamber 25 (or incineration chamber), along the interior of the thermal power plant 3 and in so doing comes into contact with the walls of the thermal power plant or heat exchangers 20 arranged therein. Here, the flue gas flows, starting from the fuel chamber 25, for example via various superheaters 34 as far as a convection part 27 (arranged here vertically), before it reaches what is known as the DeNOx part 35 for elimination of nitrogen oxides. Even with such a thermal power plant 3, a wide of cleaning devices are used: In the region of the fuel chamber 25, wall deslaggers and/or water lance blowers for example; in the region of the superheater 34, oscillating soot blowers, axial soot blowers, long retractable soot blowers and/or dual-media soot blowers; in the region of the convection part 27, axial soot blowers, part retractable soot blowers and/or rake soot blowers, and in the region of the DeNOx part 35, rake soot blowers.

Although only thermal power plants from the field of waste incineration and the utility industry are illustrated here in the figures, the invention can in principle also be used in all other thermal power plants, in particular including in the paper industry, biomass industry, petrochemical industry, etc.

The invention has therefore achieved the objective, in the case of cleaning devices that plunge for example deep into the interior of the thermal power plant, of monitoring and adapting to the external ambient conditions the functionality or the actual mode of operation of the cleaning device. In addition, a cleaning device for a thermal power plant has also been specified, which, as required, can be adapted to different positions or to predetermined situations for use. In particular, the possibility of providing information concerning the operating state of the cleaning device and/or the environment of the cleaning device in the interior of the thermal power plant has been provided. In addition, a method has also been specified, with which such a cleaning device can be installed or retrofitted accordingly. Lastly, the invention has also specified a method for cleaning a thermal power plant, with which improved monitoring of the tendency for slagging and pollution and of the cleaning efficacy during operation of the cleaning device or of the thermal power plant is made possible.

### LIST OF REFERENCE SIGNS

1 cleaning device
2 interior
3 thermal power plant
4 lance
5 main body
6 lance add-on part
7 nozzle
8 longitudinal drive
9 axis
10 sensor
11 evaluation unit
12 connection means
13 data transmitter
14 wall
15 hatch
16 control
17 fluid line
18 connection
19 data receiver
20 heat exchanger
21 holder
22 rotary drive
23 pivotable water lance
24 suspended hose system
25 fuel chamber
26 empty pass
27 convection part
28 signal conductor
29 direction of travel
30 direction of rotation
31 direction of spraying
32 distributor
33 combustion material
34 superheater
35 DeNOx part

1. A cleaning device for an interior of a thermal power plant carrying flue gas, said cleaning device comprising at least one rigid lance having a main body and at least one lance add-on part, which comprises at least one nozzle, wherein the lance add-on part is connected detachably to the main body.

2. The cleaning device as claimed in claim 1, wherein the lance comprises a longitudinal drive for moving the lance in the direction of an axis of the lance.

3. The cleaning device as claimed in claim 1, wherein at least the lance add-on part comprises at least one sensor for measuring an ambient parameter.

4. The cleaning device as claimed in claim 3, wherein at least one sensor for measuring an external temperature is provided.

5. The cleaning device as claimed in claim 4, wherein the at least one sensor is connectable to an evaluation unit, and the lance add-on part comprises connection means for a data transfer from the at least one sensor to the evaluation unit.

6. The cleaning device as claimed in claim 4, wherein the connection means comprise at least one data transmitter for wireless connection to the evaluation unit.

7. A thermal power plant with an interior carrying flue gas, comprising at least one cleaning device as claimed in claim 1, wherein a wall of the interior has at least one hatch, in which the lance can be introduced at least via the lance add-on part into the interior, and a longitudinal drive for moving the lance in the direction of an axis through the hatch is provided and is arranged on a side of the wall opposite the interior.

8. The thermal power plant as claimed in claim 7, wherein the lance add-on part is formed with at least one sensor and one data transmitter for wireless connection to an evaluation unit arranged outside the interior, and the evaluation unit is connected to the longitudinal drive.

9. A method for installing a cleaning device for an interior of a thermal power plant carrying flue gas, wherein the cleaning device comprises at least one rigid lance, and the method comprises at least the following steps:
a) separating the rigid lance of the cleaning device into a lance add-on part comprising at least one nozzle and a main body,
b) positioning at least one sensor on the lance add-on part,
c) providing remote data transfer from the sensor to an evaluation unit,
d) connecting the lance add-on part to the main body.

10. A method for cleaning a thermal power plant comprising an interior carrying flue gas by means of at least one cleaning device, which comprises a rigid lance having at least one sensor on a lance add-on part of the lance, said method comprising at least the following steps:
i) introducing the lance add-on part in one of (a) the lance and (b) an interior of the thermal power plant,
ii) measuring an ambient parameter,
iii) transmitting the measurement signals to an evaluation unit,
iv) selecting an operating mode of the at least one cleaning device,
v) cleaning predetermined regions of the interior in accordance with the selected operating mode.

11. The cleaning device as claimed in claim 3, wherein at least one sensor for measuring an internal temperature of the lance is provided.
